(19) United States
(12) Patent Application Publication
(10) Pub. No.: US 2015/0194146 A1
(43) Pub. Date: Jul. 9, 2015

(54) Intelligent Conversion of Internet Content

(71) Applicant: Futurewei Technologies, Inc., Plano, TX (US)

(72) Inventors: Zonghuan Wu, Cupertino, CA (US); Murat Kalender, Istanbul (TR); Omer Sonmez, Istanbul (TR)

(21) Appl. No.: 14/588,705

(22) Filed: Jan. 2, 2015

Related U.S. Application Data
(60) Provisional application No. 61/923,435, filed on Jan. 3, 2014.

(51) Int. Cl. G10L 13/04; H04N 21/482; H04N 21/61; G06F 17/27; H04N 21/472; G11B 27/031; G06F 17/28

(52) U.S. Cl. CPC G10L 13/043; G11B 27/031; H04N 21/482; G06F 17/28; G06F 17/2785; H04N 21/47205; H04N 21/6125

(57) ABSTRACT

An apparatus comprises a data acquisition module configured to extract raw data, and aggregate the raw data to form aggregated data, a data curation module coupled to the data acquisition module and configured to perform curation of the aggregated data to form curated data, and transform the curated data into structured format data, and a transmitter coupled to the data curation module and configured to transmit the structured format data. A method comprises receiving an instruction to perform at least a portion of videolization for a topic, extracting raw data in response to the instruction, aggregating the raw data to form aggregated data, performing curation of the aggregated data to form curated data, transforming the curated data into structured format data, and transmitting the structured format data.

### CROSS-REFERENCE TO RELATED APPLICATIONS

This application claims priority to U.S. provisional patent application No. 61/923,435 filed Jan. 3, 2014 by Zonghuan Wu, et al., and titled “Intelligent Conversion of Internet Content,” which is incorporated by reference.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Previously, newspapers, radio, and television (TV) were the primary sources of media content, or data. Over the last few decades, the Internet has become the primary source of media content. According to at least one poll in the United States, more than 50% of respondents said that they would choose the Internet as their source of news, followed by 21% for TV and 10% for both radio and newspapers.

Typically, people access the Internet on conventional Internet devices such as desktop computers, laptop computers, tablets, and mobile phones. There has been little overlap among the content sources. For example, newspapers have not typically overlapped with radio, radio has not typically overlapped with TV, and TV has not typically overlapped with the Internet.

In addition, new Internet devices are emerging. Those devices include devices employing in-car Internet, wearable devices such as Google Glass and Apple Watch, and household Internet-enabled devices. Those devices typically have screens for displaying video and speakers for playing audio. Those devices provide different user experiences from conventional Internet devices.

### SUMMARY

In one embodiment, the disclosure includes an apparatus comprising a data acquisition module configured to extract raw data, and aggregate the raw data to form aggregated data, a data curation module coupled to the data acquisition module and configured to perform curation of the aggregated data to form curated data, and transform the curated data into structured format data, and a transmitter coupled to the data curation module and configured to transmit the structured format data.

In another embodiment, the disclosure includes an apparatus comprising a receiver configured to receive structured format data that is based on curation of raw data, a video generation module coupled to the receiver and configured to perform text-to-speech (TTS) conversion of the structured format data, perform visual optimization of the structured format data, perform encoding, decoding, or both encoding and decoding of the structured format data, and render the structured format data to form a video, and presentation components coupled to the video generation module and configured to present the video.

In yet another embodiment, the disclosure includes a method comprising generating a home menu comprising an application icon associated with an application, receiving a first instruction to execute the application, generating, in response to receiving the first instruction, a channel menu comprising a channel icon associated with a channel, wherein the channel is a representation of a category of data, receiving a second instruction to execute the channel, generating, in response to receiving the second instruction, a topic menu comprising a topic icon associated with a topic, wherein the topic is a representation of a sub-category of the data, receiving a third instruction to execute the topic, and performing, in response to receiving the third instruction, at least a portion of videolization for the topic.

In yet another embodiment, the disclosure includes a method comprising receiving an instruction to perform at least a portion of videolization for a topic, extracting raw data in response to the instruction, aggregating the raw data to form aggregated data, performing curation of the aggregated data to form curated data, transforming the curated data into structured format data, and transmitting the structured format data.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is an illustration of a smart TV screen.

FIG. 2 is an illustration of a Web2TV presentation.

FIG. 3 is an illustration of a Guide presentation.

FIG. 4 is a schematic diagram of a client-server system according to an embodiment of the disclosure.

FIG. 5 is a schematic diagram of the videolization application in FIG. 4 according to an embodiment of the disclosure.

FIG. 6 is a schematic diagram of a repository according to an embodiment of the disclosure.

FIG. 7 is a schematic diagram of a logical layer system according to an embodiment of the disclosure.

FIG. 8 is an illustration of a video of the social channel in FIG. 7 according to an embodiment of the disclosure.

FIG. 9 is an illustration of a video of the encyclopedia channel in FIG. 7 according to an embodiment of the disclosure.

FIG. 10 is an illustration of an electronic program guide (EPG) channel screen according to an embodiment of the disclosure.

FIG. 11 is an illustration of a video of the web channel in FIG. 7 according to an embodiment of the disclosure.

FIG. 12 is a flowchart illustrating a method of videolization according to an embodiment of the disclosure.

FIG. 13 is an illustration of a channel selection screen according to an embodiment of the disclosure.

FIG. 14 is a flowchart illustrating a method of videolization according to another embodiment of the disclosure.

FIG. 16 is a schematic diagram of a network device.

### DETAILED DESCRIPTION

It should be understood at the outset that, although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Conventional content consumption on a TV comprises watching a television show or movie and is therefore considered a passive process. In contrast, conventional content consumption via the Internet comprises browsing to various Internet webpages via an Internet browser program on a device and is therefore considered an active process. Recently, there has been some overlap between TV consumption and Internet consumption. For example, users can now access the Internet on smart TVs or by connecting various products to TVs. Some examples of those products are Yahoo! Connected TV, Xbox, Google Chromecast, and set-top boxes (STBs). Those products may include Internet browsers and keyboards.

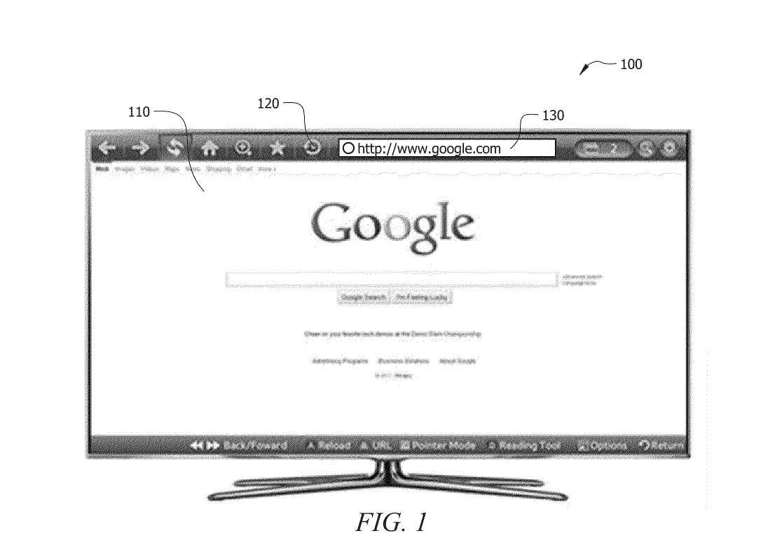

FIG. 1 is an illustration of a smart TV screen 100. The smart TV screen 100 displays a webpage 110, buttons 120, and a uniform resource location (URL) field 130. The webpage 110 displays content from the corresponding website, in this case http://www.google.com. The buttons 120 are clickable buttons so that a user may toggle through them or hover a pointer over them, then click on them. A user may enter a URL in the field 130 in order to browse to the webpage corresponding to the entered URL.

Alternatively, content consumers can access TV on conventional Internet devices using various Internet Protocol TV (IPTV) programs. Despite the advent of those technologies, users have not significantly altered their preference for consuming the Internet on their conventional Internet devices. That preference is at least partly due to the fact that Internet webpages are typically designed for presentation in browsers supported on such devices. When consuming the Internet on TVs, webpages may extend beyond the viewable region of the TV, so users may have to repeatedly scroll down or across in order to view webpages. That scrolling is particularly cumbersome when using a TV remote control. A similar issue occurs when providing Internet content on tablets and mobile phones, which typically have smaller screens than desktop computers and laptop computers. Furthermore, tablets and mobile phones typically have touchable screens and are typically operated by touches and flips rather than keyboard strokes, making it more difficult to navigate Internet content.

Flipboard is one solution to the issue of navigating Internet content on tablets and mobile phones. Flipboard collects content from webpages and presents that content in a magazine format that allows users to flip through it. Flipboard provides news for users who desire the ease of browsing a newspaper, but with the freedom to gather news from multiple sources. Flipboard exploits the advantages of tablets and mobile devices in order to provide Internet content. Similarly, a new technique should exploit the advantages of TVs.

In order to effectively provide Internet content on TVs, there is a need to convert that content into a format that is more easily consumed on TVs. Due to the large screen size of TVs, that format may primarily be video. Because there are at least 3.78 billion webpages and because that number is growing dramatically, manual conversion of Internet content onto a TV is infeasible. There is therefore a need to provide Internet content on a TV in an automatic fashion. While entire webpages may be read out through a TV, users instead desire concise and easy-to-navigate content. Understanding how to convert Internet content requires understanding webpages that are in natural language, so conversion is an artificial intelligence (AI) issue.

Some prior approaches have been proposed. For example, Katsumi Tanaka, “Research on Fusion of the Web and TV Broadcasting,” Second International Conference on Informatics Research for Development of Knowledge Society Infrastructure, 2007, which is incorporated by reference, describes three approaches. A first approach, u-Pav, reads out the entire content of webpages and presents image animation. The audio component derives from text, which is articulated using synthesized speech. For the visual component, the title and lines are shown through a ticker, and keywords and images are animated. u-Pav synchronizes the tickers, animations, and speech. Web2TV is a second approach.

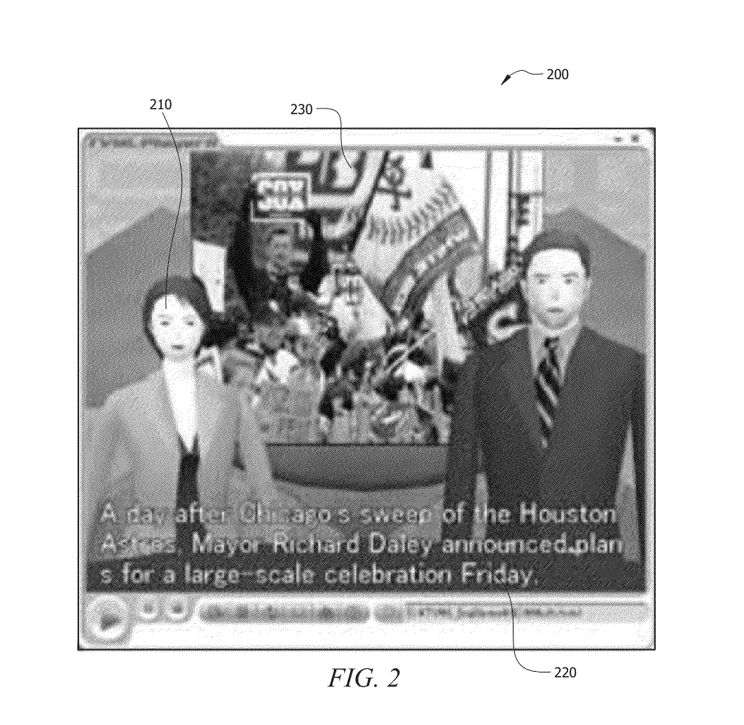

FIG. 2 is an illustration of a Web2TV presentation 200. The presentation 200 comprises avatars 210, text 220, and a background 230. As can be seen, Web2TV looks like a headline news program. The avatars 210 read out the entire text of webpages, the text 220 repeats the content, and images in the background 230 are synchronized with the reading from the avatars 210.

A third approach, Web2Talkshow, presents keyword-based dialogue and avatar animation. Declarative sentences on webpages are transformed into humorous dialogue based on keywords extracted from webpages. Those three approaches enable users to consume Internet content in the same way that they watch TV, but they do not effectively or efficiently provide Internet content because they read out the entire text of webpages.

Kylo is an Internet browser for TVs. It comprises large fonts and buttons for easy viewing from across a room, making it especially suitable for use with a home theater personal computer (HTPC) connected directly to a high-definition (HD) TV. Kylo optimizes only the font of webpages, which does not solve the problem of surfing the Internet on the TV.

Stupeflix is a video editing product that provides for semi-automatically generating videos from photos, video, and music. Stupeflix offers an application programming interface (API) for video generation and supports video editing functionalities that may be useful, but like Kylo does not solve the problem of surfing the Internet on the TV.

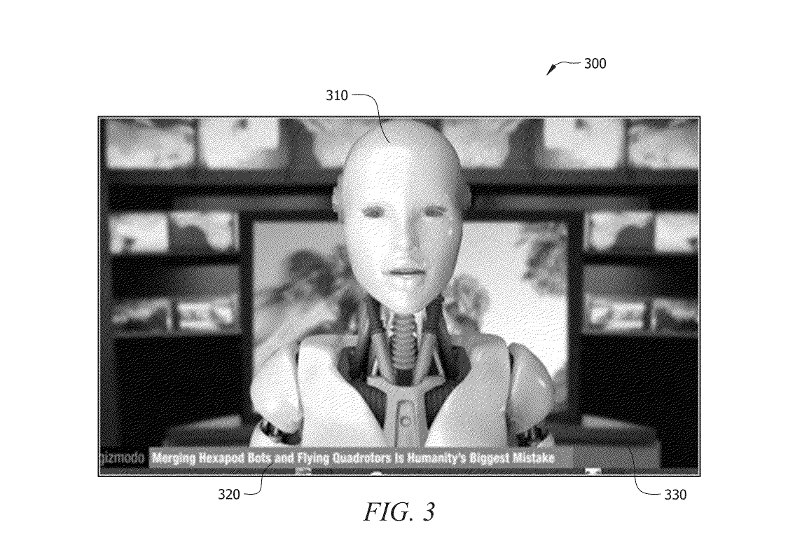

FIG. 3 is an illustration of a Guide presentation 300. The presentation 300 comprises an avatar 310, text 320, and a background 330. The presentation 300 is similar to the presentation 200 in that the avatar 310 reads out the Internet content and the text 320 repeats the content. However, unlike the presentation 200, the background 330 in the presentation 300 is more static and made to look like a newsroom set. Guide converts Internet news and blogs into videos. Guide promotes generating videos in real time using technologies such as TTS, avatars, social media, and various processing. Guide, however, presents only news webpages, has no AI or interactivity, is not customizable based on user profiles, and supports only English.

Disclosed herein are embodiments for videolization. Videolization is defined as, for instance, the intelligent conversion of raw content into personalized videos. The videos comprise any combination of text, audio, and video (or motion picture) content. The raw content may derive from the Internet, and the audio and video content may be provided on a TV. The conversion incorporates analyses, AI, and customization in order to provide a personalized and user-friendly experience so that users can watch and listen to the Internet instead of having to read individual webpages. Users can customize the content, which is categorized based on the source and type of content. Each category is presented as a separate TV channel. Videolization solves the issue of effectively providing Internet content on a TV; provides convenience by allowing a user to watch Internet content instead of read it; saves time by allowing a user to consume Internet content while performing daily rituals; enriches a TV experience by adding Internet content; and provides entertainment by presenting Internet content in a fun, visual, and interactive manner. While the disclosed embodiments are described as providing Internet content, they may also apply to processing any content, including content stored locally or on a local area network (LAN). Furthermore, while the disclosed embodiments are described for TVs, they may extend to other devices, including conventional Internet devices such as desktop computers, laptop computers, tablets, and mobile phones, as well as new Internet devices such as devices employing in-car Internet, wearable devices such as Google Glass and Apple Watch, and household Internet-enabled devices.

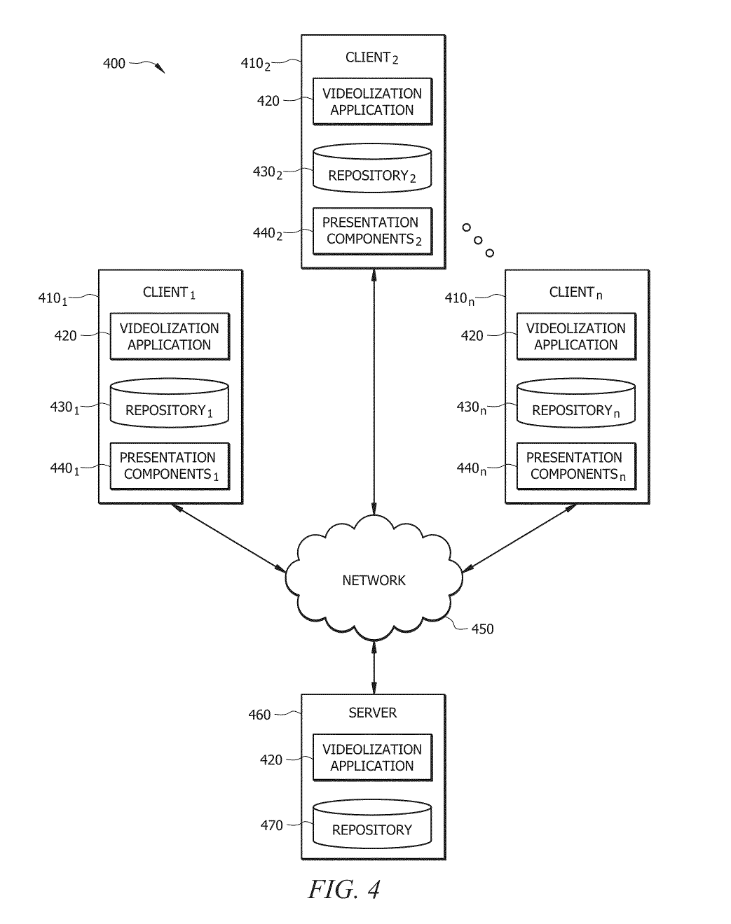

FIG. 4 is a schematic diagram of a client-server system 400 according to an embodiment of the disclosure. The system 400 comprises n clients 410, a server 460, and a network 450 communicatively coupling the clients 410 and the server 460. N is any positive integer. The components of the system 400 are communicatively coupled to each other via any suitable wired or wireless channels and communicate with each other using any suitable protocols. The components of the system 400 may be arranged as shown or in any other suitable manner.

The clients 410 are any hardware devices configured to process data. The clients are associated with end users. For instance, the clients 410 may be TVs. Alternatively, the clients 410 may be servers communicatively coupled to end user devices such as TVs. The clients 410 each comprise a videolization application 420, a repository 430, and presentation components 440.

The application 420 is any software configured to perform videolization or a portion of videolization. The application 420 may be a stand-alone application or a plugin application. In the clients 410, the application 420 may be associated with a user interface. In the server 460, the application 420 may not be associated with a user interface. The application 420 may have client-specific processes in the clients 410 and server-specific processes in the server 460. The application 420 may be a separate component in the clients 410 and the server 460, and those separate components may collaborate to perform videolization. Otherwise, the application 420 may function similarly in the clients 410 and the server 460. The application 420 supports various standards and platforms. For instance, the application 420 supports video encoding standards such as MP4/H.264, which are incorporated by reference. The application 420 further supports operating systems (OSs) such as iOS, Android, and Windows, which are incorporated by reference. The application 420 is described more fully below.

The repositories 430 are any hardware components or logical partitions of hardware components configured to store data. The repositories 430 are associated with the application 420 and store videolization-related data. The repositories 430 are described more fully below.

The presentation components 440 are any combination of hardware components and software configured to present videolization data. The presentation components 440 communicate with the application 420 in order to present the videolization data. The presentation components 440 comprise a screen and speakers to present the videolization data.

The network 450 is any network or service tunnel configured to provide for communication among the components of the system 400. For instance, the network 450 may be the Internet, a mobile telephone network, an LAN, a wide area network (WAN), or another network. Alternatively, the network 450 may be a dedicated channel between the clients 410 and the server 460. The network 450 provides for communication along any suitable wired or wireless channels.

The server 460 is any hardware device configured to process data. The server 460 may be configured to perform tasks for the clients 410. For instance, the server 460 may be a dedicated hardware computer server. The server 460 comprises the application 420 and a repository 470. The repository 470 may function similarly to the repositories 430. The server 460 may represent multiple servers.

Proper videolization implementation requires understanding how users consume Internet content. Users spend about 22% of their time on the Internet on social network websites, 21% on searches, 20% on reading content, 19% on emails and communication, 13% on multimedia websites, and 5% shopping. The most frequent actions on the Internet are sending emails; using search engines; shopping; and reviewing content on health, hobbies, the weather, news, and entertainment. Google, a search engine website, is one of the top 10 most popular websites and has over 153 million unique visitors each month. Almost 137 million people use Facebook, a social network website. Other popular websites are YouTube, Microsoft, AOL, Wikipedia, Apple, and MSN. The statistics above, as well as other data, may help determine what type of channels and other functions the application 420 should implement.

Successful videolization implementation satisfies various metrics, which comprise performance, scalability, optimization, quality, richness, usability, freshness, and reliability. The performance metric requires speed and efficiency. The scalability metric requires service to millions of clients 410.

The optimization metric requires videolization to use the least amount of resources necessary. As a first example, the server 460 collects and processes data, the server 460 packages the data in a structured format, the server 460 transmits the structured format data to the clients 410, and the clients 410 generate a video based on the structured format data. Optimization reduces network communication overhead and shares the computational load between the clients 410 and the server 460. As a second example, the clients 410 perform videolization offline so that users do not have to wait. For instance, for social network websites, it may be infeasible to generate videos online because of the high volume, variety, and velocity of data on those websites. In order to reduce user waiting time, the clients 410 store and present one video while generating other videos.

The quality metric requires that video be at least HD as low-resolution video may not be suitable for TV. Videolization is able to produce, for instance, full HD (e.g., 640×480 pixels and 1920×1080 pixels), 4K resolution, and 8K resolution video. The richness metric dictates the number of episodes for a channel. For instance, a user should be able to watch different episodes for at least an hour at a time.

The usability metric requires an intuitive, user-friendly experience to account for the fact that users may be of all different types, some of whom may not have experience with typical Internet-enabled devices. Users should be able to understand videolization within seconds after viewing a home page. The freshness metric requires that videos of the latest content be presented. This metric is particularly important for social network and news content. The reliability metric requires only a few failures per week. Other metrics may further dictate videolization implementation.

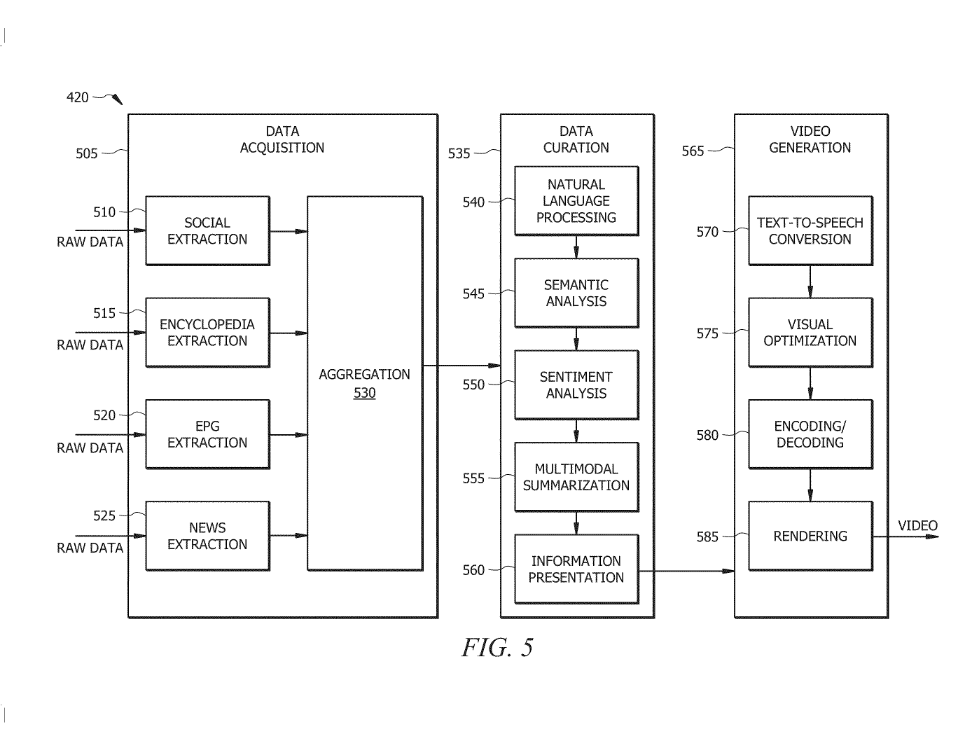

FIG. 5 is a schematic diagram of the videolization application 420 in FIG. 4 according to an embodiment of the disclosure. The application 420 comprises a data acquisition module 505, a data curation module 535, and a video generation module 565. The components of the application 420 may be arranged as shown or in any other suitable manner.

The data acquisition module 505 is configured to acquire raw data from sources such as webpages via the network 450. The raw data include HyperText Markup Language (HTML), Extensible Markup Language (XML), image, text, audio, and video files. The data acquisition module 505 comprises a social extraction module 510, an encyclopedia extraction module 515, an EPG extraction module 520, a news extraction module 525, and an aggregation module 530. The social extraction module 510 is configured to extract raw social data such as data from social network websites like Facebook, the encyclopedia extraction module 515 is configured to extract raw educational data such as data from websites like Wikipedia, the EPG extraction module 520 is configured to extract raw TV program and movie data such as data from websites like TV Guide, and the news extraction module 525 is configured to extract raw news data such as data from websites like CNN. The extraction modules then transmit the raw data to the aggregator 530. The extraction modules are associated with channels, which are described more fully below. The data acquisition module 505 may comprise any other suitable extraction modules, for instance extraction modules corresponding to the channels described below. The aggregator 530 is configured to receive the extracted data from the extraction modules, aggregate the extracted data into aggregated data, which may be a data unit or stream, and transmit the data unit or stream to the data curation module 535.

The data curation module 535 is configured to receive the data unit or stream from the data acquisition module 505 and curate that data. Curation is defined as the process of determining what data to present and how to present it. For instance, curation determines at least the following: 1) what subset of data, from a larger set of data, to present (e.g., if 100 images are relevant, but only two images are selected); 2) where to present the data (e.g., text on bottom and video on top); and 3) how to present the data (e.g., text is Times New Roman). The data curation module 535 comprises a natural language processing (NLP) module 540, a semantic analysis module 545, a sentiment analysis module 550, a multimodal summarization module 555, and an information presentation module 560.

The NLP module 540 is configured to extract and process text from the data using machine learning methods and other techniques. The NLP module 540 is further configured to employ language-specific tools to analyze the text for identification, analysis, and description of the structure of a language's morphemes and other linguistic units. The NLP module 540 may employ Apache OpenNLP, which is incorporated by reference, or another suitable NLP technique.

The semantic analysis module 545 is configured to annotate, or tag, data to associate names, attributes, comments, descriptions, and other data with the text. In other words, semantic analysis provides metadata, or data about data. Such metadata helps clarify the ambiguity of natural language when expressing notions and their computational representation in a formal language. By evaluating how data are related, it is possible to process complex filter and search operations.

The sentiment analysis module 550 is configured to perform opinion mining. Opinion mining is defined as obtaining opinions about data. The sentiment analysis module 550 obtains the opinions from webpages, the repositories 430, and the repository 470, then associates those opinions with the data. When a user wants to buy a product, the user may read others' reviews about the product before buying the product. Accordingly, the sentiment analysis module 550 saves a user time by providing opinions about data without requiring the user to search for those opinions on his or her own.

The multimodal summarization module 555 is configured to perform multimodal summarization. Multimodal summarization is defined as converting complex data into less complex data. For instance, multimodal summarization identifies the main idea of a complex sentence, creates a less complex summary of the complex sentence, adds helpful data such as images and videos to the less complex summaries, and provides a structure to relate the less complex summary to the helpful data.

The information presentation module 560 is configured to determine how to present the data. The information presentation module 560 may employ a template-based methodology to do so. The information presentation module 560 obtains the templates from the repositories 430 and the repository 470. As a first example, for data on a movie, a video plays a trailer of the movie as a background or shows images in the background if a trailer is not available. An avatar reads out the movie title, the names of the actors and directors, a brief description of the movie, and critical reviews. As a second example, for other webpages not devoted to a single topic such as news webpages, the template follows a document flow. The avatar reads important parts of the webpage while the remaining parts of the webpage are shown as text on the screen. While the avatar reads out the content, the video shows text, images, videos based on the context of what is being read. The information presentation module 560 obtains the images from webpages, the repositories 430, and the repository 470. Alternatively, the information presentation module 560 synthesizes images for select types of data. For instance, it may hard to find images for temporal expressions. Quantities in text may require special handling, so the information presentation module 560 may convey information related to quantities in a comprehensive manner by employing synthesized imagery. The information presentation module 560 then transforms the curated data into a structured format, for instance an XML document. Finally, the information presentation module 560 transmits the structured format data to the video generation module 565.

The video generation module 565 is configured to receive the structured format data and generate the final video using image and video processing techniques. The video generation module 565 may perform its functions on portions of data. For instance, if the video generation module 565 receives an XML document from the information presentation module 560, then the video generation module 565 may download a first portion of the data via a first link in the XML document, process the first portion, download a second portion of the data via a second link in the XML document, process the second portion, and so on.

The video generation module 565 comprises a TTS conversion module 570, a visual optimization module 575, an encoding/decoding module 580, and a rendering module 585. The TTS conversion module 570 is configured to convert text to speech. The visual optimization module 575 is configured to scale, resize, filter, and perform other suitable techniques in order to provide a visually pleasing video. The encoding/decoding module 580 is configured to encode or decode the data into a specific format. The format may or may not be standardized. Finally, the rendering module 585 is configured to render and output a video. The rendering module 585 outputs the video for presentation via the presentation components 440. The video comprises any combination of text, audio, and video.

The application 420 and its components exist and execute in the clients 410, the server 460, or any suitable combination of the two. As a first example, for relatively large-sized videos and personalized videos such as a user's own social timeline video, the data acquisition module 505 and the data curation module 535 may execute in the sever 460, while the video generation module 565 may execute in the clients 410. As a second example, for relatively small-sized videos and videos based on relatively static content such as encyclopedia content, the data acquisition module 505, the data curation module 535, and all components of the video generation module 565 except for the rendering module 585 may execute in the server 460, while only the rendering module 585 may execute in the clients 410. The server 460 may instruct the clients 410 and the server 460 to execute the various modules in order to optimize the system 400 for speed, reliability, and other metrics. As a third example, the clients 410 may present videos via their presentation components 440, while the server 460 performs all other functions.

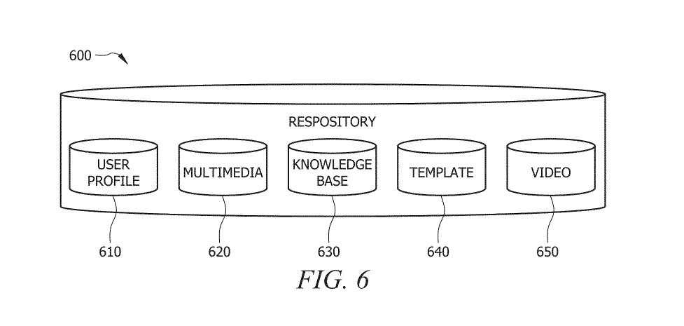

FIG. 6 is a schematic diagram of a repository 600 according to an embodiment of the disclosure. The repository 600 and its components exist and execute in the repositories 430, the repository 470, or any suitable combination of the two. The repository 600 is configured to store videolization-related data collected over time as the application 420 executes. The server 460 may store in its repository 470, or the server 460 may instruct the clients 410 to store in their repositories 430, the data in a manner to further optimize the system 400 for speed, reliability, and other metrics. The repository 600 may provide a data for the application 420 to customize videos. The repository 600 comprises a user profile repository 610, a multimedia repository 620, a knowledge base repository 630, a template repository 640, and a video repository 650. The components of the repository 600 may be arranged as shown or in any other suitable manner.

The user profile repository 610 is configured to store histories, preferences, and other data related to the clients 410 and their associated users. For instance, a user may complete a profile indicating his or her biographical information, or the user profile repository 610 may store the user's biographical information that is learned over time. The data in the user profile repository 610 is then used to customize videos.

The multimedia repository 620 is configured to store various stock text, images, and videos extracted from webpages. The knowledge base repository 630 is configured to store data that can be reused and accessed for the system 400 to efficiently perform videolization. The template repository 640 is configured to store templates related to curation and other processes, including information presentation. The video repository 650 is configured to store videos that the application 420 generates. The videos that are stored may be the videos that, based on the user profile repository 610, are most likely to be reused.

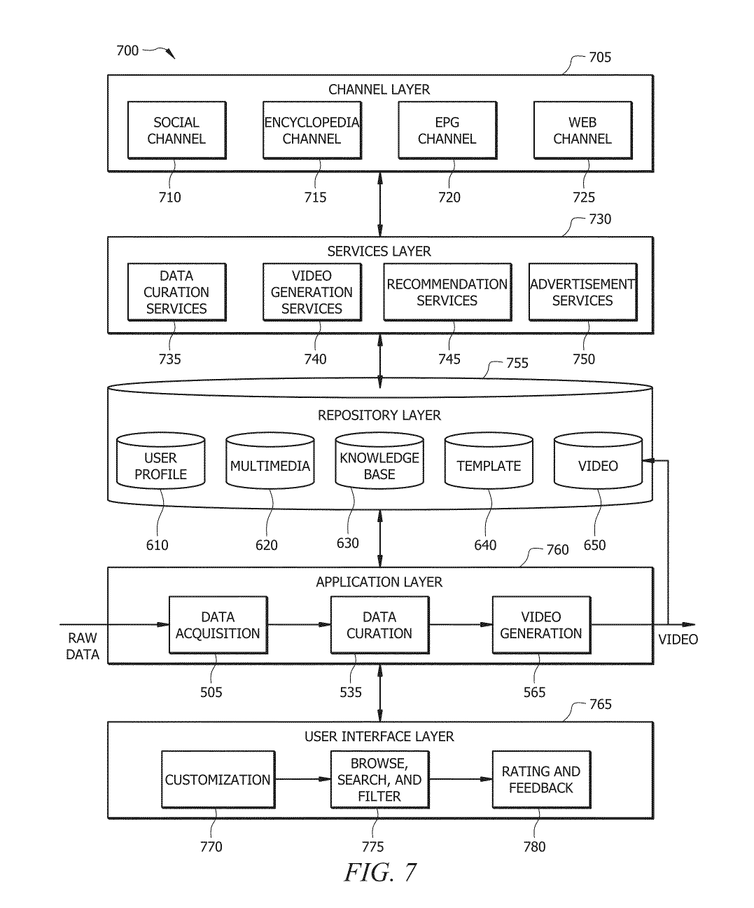

FIG. 7 is a schematic diagram of a logical layer system 700 according to an embodiment of the disclosure. The system 700 and its components exist and execute in the clients 410, the server 460, or any suitable combination of the two. The system 700 is configured to perform videolization. The system 700 comprises a channel layer 705, a services layer 730, a repository layer 755, an application layer 760, and a user interface layer 765. The components of the system 700 may be arranged as shown or in any other suitable manner.

The components are logical representations of functions that the clients 410 and the server 460 perform. The layers are designed in an object-oriented fashion considering software design principles. The layers may be integrated through APIs. Those APIs may be implemented as Internet services such as Simple Object Access Protocol (SOAP) and representational state transfer (REST), which are incorporated by reference, but other protocols may be used as well.

The software to implement the system 700 may be developed using Agile methodologies, use C++ for image and video processing, and use Java for performance and engineering concerns. Commercial and open-source software development and management tools, including OpenCV for image and video processing and OpenNLP for NLP, may be used. Agile, C++, Java, OpenCV, and OpenNLP are incorporated by reference.

The channel layer 705 is configured to collect data, sort the data into categories, and provide a channel for each category of data. A channel is defined as a representation of a category of data. The channels may share a common format. While channels are described, other representations of categories of data may be used. For instance, tree structures, graph structures, and flat structures managed through search may be used. The channel layer 705 comprises a social channel 710, an encyclopedia channel 715, an EPG channel 720, and a web channel 725 that correspond to the social extraction module 510, the encyclopedia extraction module 515, the EPG extraction module 520, and the news extraction module 525, respectively.

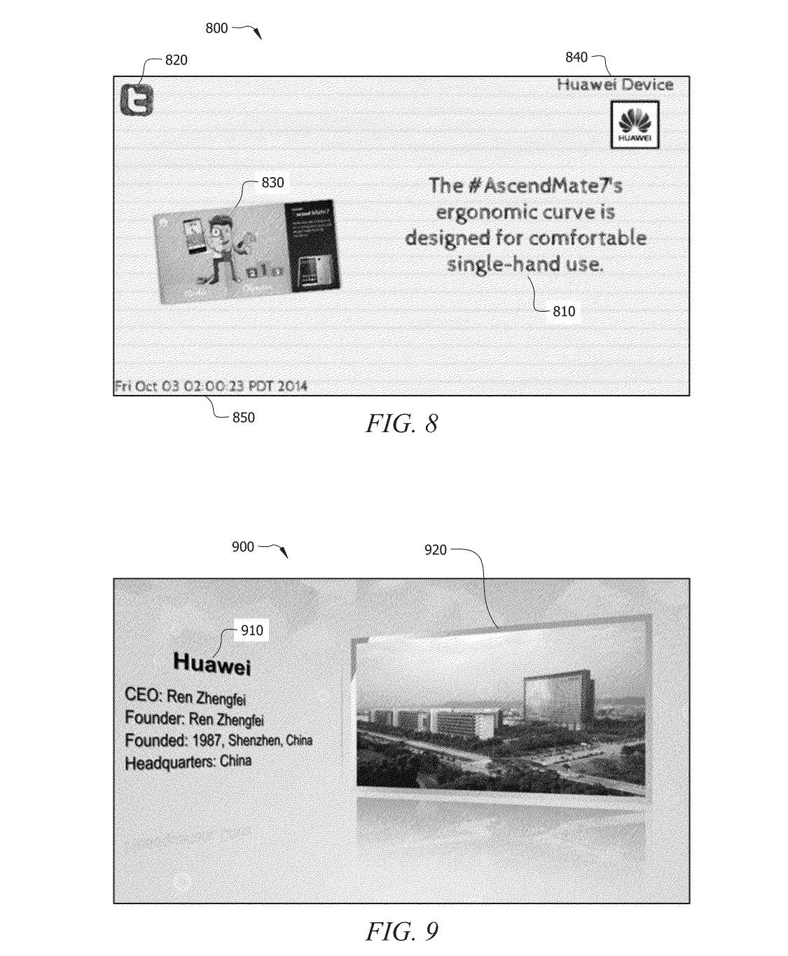

FIG. 8 is an illustration of a video 800 of the social channel 710 in FIG. 7 according to an embodiment of the disclosure. The video 800 comprises text 810 from a tweet from Twitter, a social network website; the Twitter logo 820; an image or video 830 related to the product, a mobile phone, reflected in the text; the name and logo 840 of the company, Huawei Devices, that manufactures the phone; and the date and time 850 of the tweet. The text 810 and the logo 820 may derive from Twitter's website, while the image 830 and the logo 840 may derive from Huawei's website. The social channel 710 may present a social network website and may present posts from that website as topics, or episodes. A topic is defined as a representation of a sub-category of data.

FIG. 9 is an illustration of a video 900 of the encyclopedia channel 715 in FIG. 7 according to an embodiment of the disclosure. The video 900 comprises text 910 and an image or video 920 related to a specific topic, Huawei. The text 910 and the image 920 may derive from Wikipedia's website or a website of another suitable information source, as well as Huawei's website. The encyclopedia channel 720 may present educational data about any topic.

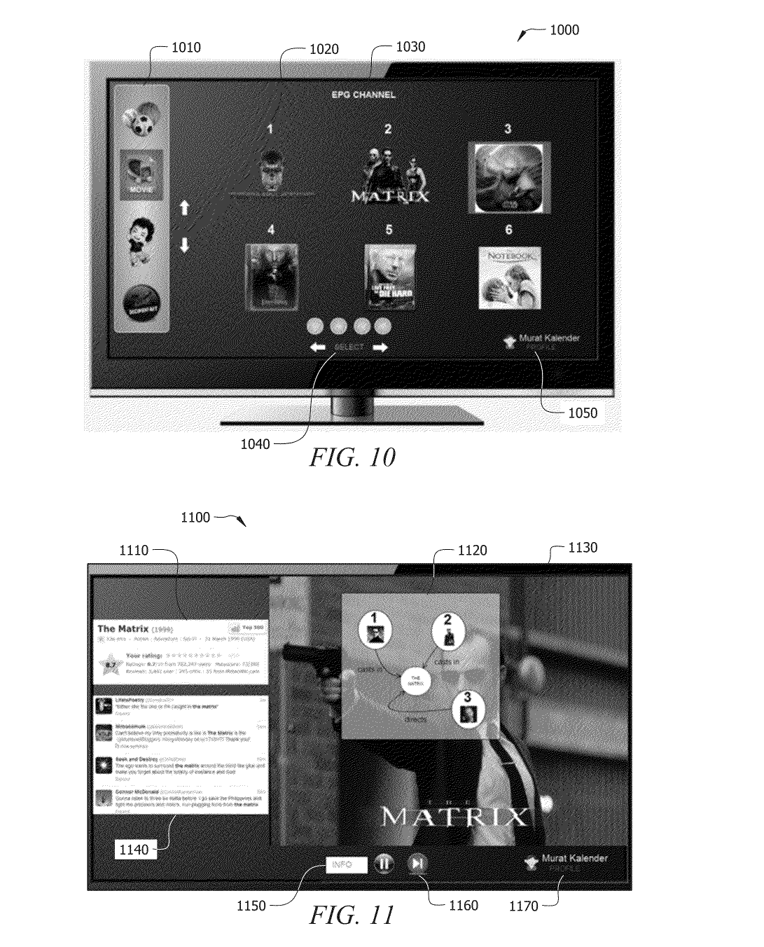

FIG. 10 is an illustration of an EPG channel screen 1000 according to an embodiment of the disclosure. The screen 1000 presents the EPG channel 720 and comprises a category selection pane 1010, a topic menu 1020, a navigation indicator 1030, a topic menu progress indicator 1040, and a user profile indicator 1050. The category selection pane 1010 indicates categories of EPG content such as sports, movies, children, and documentaries. The topic menu 1020 indicates the available topics such as The Terminator, The Matrix, Star Wars, Lord of the Rings, Die Hard, and The Notebook. The navigation indicator 1030 indicates the current navigation status, which is the EPG channel 720. The topic menu progress indicator 1040 indicates how many screens of topics exist and which screen is currently presented. The user profile indicator 1050 indicates a user currently associated with the EPG channel 720. The application 420 may customize the EPG channel 720 based on the user. The EPG channel presents movies and TV shows in an enriched format that includes related news, comments, reviews, trailers, and pictures from websites and other sources.

FIG. 11 is an illustration of a video 1100 of the web channel 725 in FIG. 7 according to an embodiment of the disclosure. The video 1100 comprises a summary 1110, an infographic 1120, a video 1130, reviews 1140, an information button 1150, control buttons 1160, and a user profile indicator 1170. The video 1100 is related to the movie The Matrix. The summary 1110 provides a brief summary of the movie, including the name of the movie, the year it released, its genres, and its average ratings. The infographic 1120 provides data about the movie in an easy-to-understand graphical form. In this case, the data relate to the actors in the movie. The video 1130 is a trailer for the movie. The reviews 1140 are reviews from users and critics. The information button 1150 is a button that, when clicked, provides more data about the movie. The control buttons 1160 allow for pausing, playing, and other controls. The user profile indicator 1170 indicates a user currently associated with the web channel 725. The web channel 725 may present webpages with options according to the type of webpage. For instance, if a user selects http://www.imdb.com, an avatar may show that information is available for movies on digital video disc (DVD) or movies in theaters. Upon selecting a movie in one of those categories, the avatar may begin a presentation of that movie. Voice control and other features may enable interaction and customization of the video 1100.

Returning to FIG. 7, the channel layer 705 may comprise any other suitable channels, for instance a personal assistant channel, a news channel, an e-shopping channel, an event channel, an instant messaging (IM) channel, a search channel, an email channel, a banking channel, and a local business channel. The personal assistant channel presents daily life information. For instance, an avatar presents a report about weather, traffic, and a user's meetings. The news channel presents data such as news articles and videos. The data may be broken into categories such as politics and sports. A user may be able to ask for news pertaining to a specific category.

The e-shopping channel presents various products for sale. The products may be currently discounted products or may be products recommended based on a user's profile. The e-shopping channel compares prices for products across multiple websites. A user can buy products through the e-shopping channel.

The event channel presents upcoming events such as concerts and movies and recommends events based on the user profile repository 610. An avatar reads event information, and a user may ask questions about events. The IM channel generates videos of instant messages from various applications and websites such as WhatsApp, WeChat, and Facebook. The IM channel uses a natural language interface to provide better interactivity. The application 420 supplements the videos with simultaneous text, audio, and video related to the instant messages.

The search channel generates videos with reorganized search results. A user inputs a search query into one of the clients 410, the data acquisition module 505 retrieves search results based on the search query, the data curation module 535 curates the results, and the video generation module 565 presents the data in a video. The email channel presents an avatar that reads the emails and presents images and videos that are attached or linked. The email channel may enrich emails with data that are related to extracted keywords in the emails, screenshots of webpages linked to in the emails, and background music. The email channel may summarize long emails when appropriate.

The banking channel presents videos of personal financial data. The videos comprise statuses of a user's bank accounts and investments, personalized investment suggestions, income-expense balance graphics, required and pending payments, and general financial data such as currency exchange rates and stock market news. The local business channel is an interactive review and recommendation channel associated with local businesses. The channel recommends places such as restaurants, cafés, bars, shops, hotels, and cinemas based on the user's location and other data such as data in the user profile repository 610. The user can search for businesses and receive a video of suggested businesses along with those businesses' reviews.

The services layer 730 comprises data curation services 735, video generation services 740, recommendation services 745, and advertisement services 750. The server 460 or an administrator associated with the server 460 may oversee the services layer 730. The data curation services 735 and video generation services 740 supplement the data curation module 535 and the video generation module 565, respectively. Specifically, the data curation services 735 are configured to provide data related to curation, including updates to NLP, semantic analysis, sentiment analysis, multimodal summarization, and information presentation techniques. Similarly, the video generation services 740 are configured to provide data related to video generation, including updates to TTS, visual optimization, encoding/decoding, and rendering techniques. The recommendation services 745 and the advertisement services 750 both provide recommendations for additional content that users may desire, though the advertisement services 750 may do so for a fee charged to sponsors. The advertisement services 750 may comprise metadata support and providing advertisements before, during, and after videos.

The repository layer 755 functions similarly to the repository 600. The repository layer 755 comprises the user profile repository 610, the multimedia repository 620, the knowledge base repository 630, the template repository 640, and the video repository 650. The application layer 760 functions similarly to the application 420. The application layer 760 comprises the data acquisition module 505, the data curation module 535, and the video generation module 565.

The user interface layer 765 is configured to provide an interface between the user and his or her client 410 on one hand and the application 420 on the other hand. The user interface layer 765 implements human-computer interact (HCI) studies such as Vibeke Hansen, “Designing for interactive television v 1.0,” BBCi & Interactive tv programmes, 2005, which is incorporated by reference, as well as design principles for usability. The user interface layer 765 comprises a customization module 770; a browse, search, and filter module 775; and a rating and feedback module 780.

The customization module 770 is configured to allow the user to customize the application 420 by layout, color, texture, content, and other features. The browse, search, and filter module 775 is configured to allow the user to browse for, search for, and filter content as he or she desires. Browsing comprises browsing from a home menu of one of the clients 410 to a channel menu, then to a topic menu, and finally to a video of a chosen topic. Browsing and the channel menu are described more fully below. Searching comprises entering terms into a search field that may be on the home menu or the channel menu. Alternatively, searching comprises searching via the search channel described above. Filtering comprises filtering content that the user desires. For instance, the user may add and remove channels and topics as he or she desires, or the user may filter the channels and topics to show only the most popular or trending ones. The rating and feedback module 780 is configured to allow the user to provide ratings and feedback for viewed videos. Other users may then receive those ratings and feedback.

In operation, the system 700 performs videolization when the application layer 760 extracts raw data; processes the data through the data acquisition module 505, the data curation module 535, and the video generation module 565; and outputs the final video. The application layer 760 also retrieves data from the channel layer 705, the services layer 730, the repository layer 755, and the user interface layer 765 in order to perform or enhance videolization. The application layer 760 outputs the video for presentation via the presentation components 440 and transmits the video to the video repository 640 for storage.

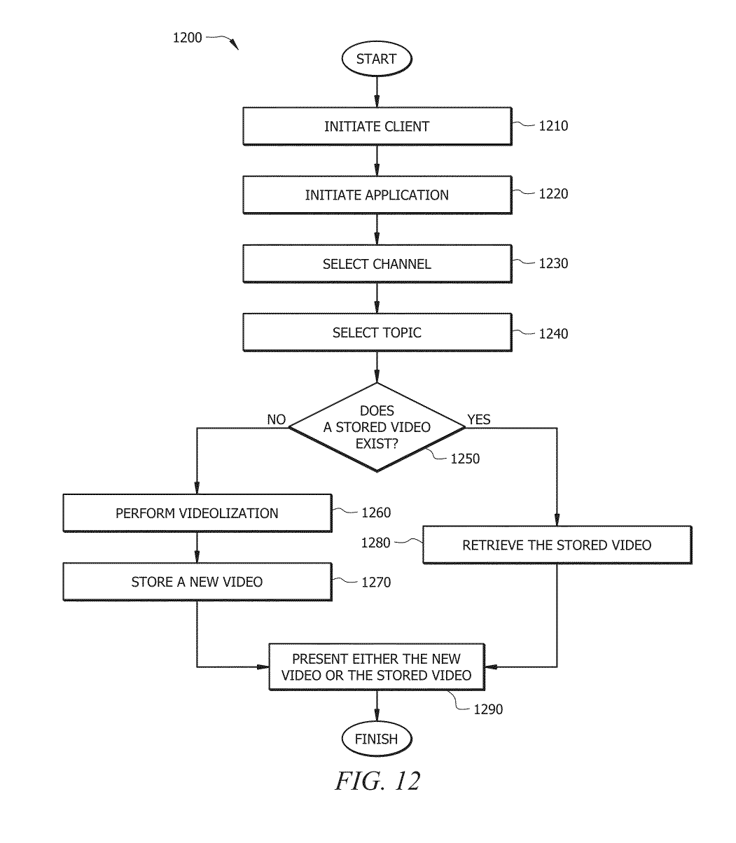

FIG. 12 is a flowchart illustrating a method 1200 of videolization according to an embodiment of the disclosure. The method 1200 may be implemented in the system 400 or the system 700. At step 1210, a client is initiated. The client may be one of the clients 410, for instance the client₁ 410₁. A user may initiate the client₁ 410₁ by turning it on. When the user does so, the client₁ 410₁ displays via the presentation components) 440₁ a home menu comprising icons.

At step 1220, an application is initiated. The application may be the application 420 or the application layer 760, but only the application 420 is mentioned further for simplicity. The application 420 is initiated when a user executes it as a stand-alone application, which may present as a separate icon on the home menu. Alternatively, the application 420 is initiated when a user executes it as a plug-in application, which may present as a drop-down menu selection in another application. Upon execution of the application 420, the application 420 displays a channel menu.

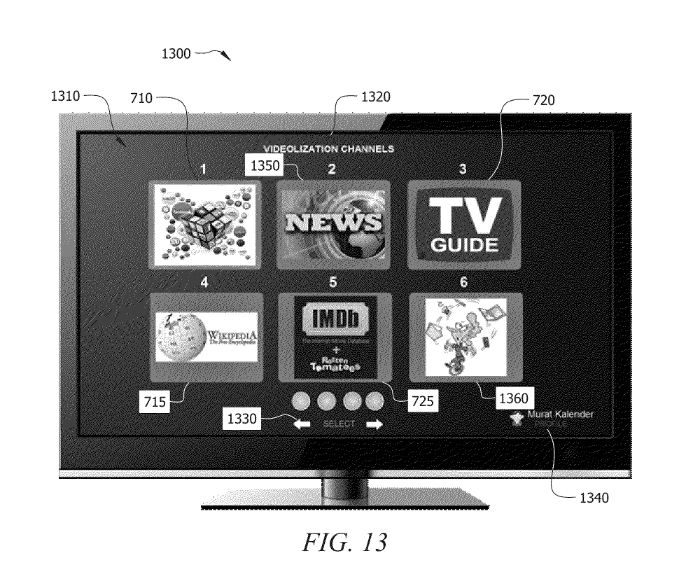

FIG. 13 is an illustration of a channel selection screen 1300 according to an embodiment of the disclosure. The screen 1300 comprises a channel menu 1310, a navigation indicator 1320, a channel menu progress indicator 1330, and a user profile indicator 1340. The channel display 1310 indicates the available channels such as the social channel 710, the news channel 1350, the EPG channel 720, the encyclopedia channel 715, the web channel 725, and the children's channel 1360. The navigation indicator 1320 indicates the current navigation status, which is a display of available channels. The channel menu progress indicator 1330 indicates how many screens of channels exist and which screen is currently presented. The user profile indicator 1340 indicates a user currently associated with the screen 1300. The application 420 may customize the screen 1300 based on the user. The EPG channel presents movies and TV shows in an enriched format that includes related news, comments, reviews, trailers, and pictures from websites and other sources.

Returning to FIG. 12, at step 1230, a channel is selected. The user selects the channel by clicking any available channel that he or she desires. The application 420 displays the channel in a manner similar to that shown in FIG. 10. At step 1240, a topic is selected. For instance, when viewing the EPG channel screen 1000, the user may select The Terminator from the topic menu 1020.

At decision diamond 1250, it is determined whether a stored video exists for the topic. For instance, the application 420 determines if a stored video for the topic exists in the video repository 650. If a stored video does not exist, then the method proceeds to step 1260. If a stored video does exist, then the method proceeds to step 1280.

At step 1260, videolization is performed. Videolization is performed when the application 420 extracts raw data; processes the data through the data acquisition module 505, the data curation module 535, and the video generation module 565; and outputs a new video. At step 1270, the new video is stored. For instance, the application 420 stores the video in the video repository 640. Finally, at step 1290, the new video is presented. For instance, the application 420 presents the new video via the presentation components₁ 440₁ of the client₁ 410₁.

At step 1280, the stored video is retrieved. For instance, the application 420 retrieves the stored video from the repository 650. Finally, at step 1290, the stored video is presented. For instance, the application 420 presents the stored video via the presentation components₁ 440₁ of the client₁ 410₁.

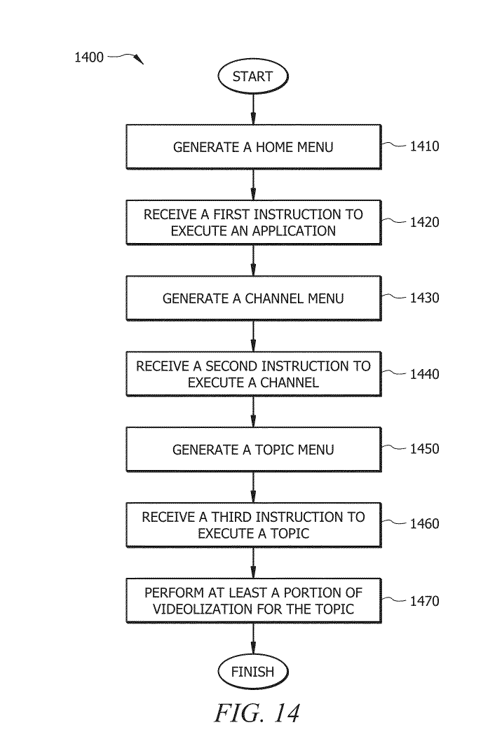

FIG. 14 is a flowchart illustrating a method 1400 of videolization according to another embodiment of the disclosure. The method may be implemented in the system 400 or the system 700, for instance in one of the clients 410 such as the client₁ 410₁. At step 1410, a home menu is generated. The home menu comprises an application icon associated with an application. The application may be the application 420.

At step 1420, a first instruction to execute the application is received. At step 1430, a channel menu is generated. The channel menu may be the channel menu 1310. The channel menu is generated in response to receiving the first instruction. The channel menu comprises a channel icon associated with a channel.

At step 1440, a second instruction to execute the channel is received. At step 1450, a topic menu is generated. The topic menu may be the topic menu 1020.

At step 1460, a third instruction to execute a topic is received. At step 1470, at least a portion of videolization for the topic is performed. For instance, the application 420 performs TTS conversion, visual optimization, encoding/decoding, and rendering in the client₁ 410₁.

FIG. 15 is a flowchart illustrating a method 1500 of videolization according to yet another embodiment of the disclosure. The method may be implemented in the system 400 or the system 700, for instance in the server 460. At step 1510, an instruction to perform at least a portion of videolization for a topic is received. For instance, the server 460 receives the instruction from one of the clients 410. The instruction may be a selection of a topic.

At step 1520, raw data is extracted. For instance, the social extraction module 510, the encyclopedia extraction module 515, the EPG extraction module 520, or the news extraction module 525 extracts raw data from the Internet. At step 1530, the raw data is aggregated to form aggregated data. For instance, the aggregation module 530 aggregates the raw data.

At step 1540, curation of the aggregated data is performed to form curated data. For instance, the data curation module 535 curates the data. At step 1550, the curated data is transformed into structured format data. For instance, the data curation module 535 transforms the curated data into an XML file. Finally, at step 1560, the structured format data is transmitted. For instance, the server 460 transmits the structured format data to one of the servers 410.

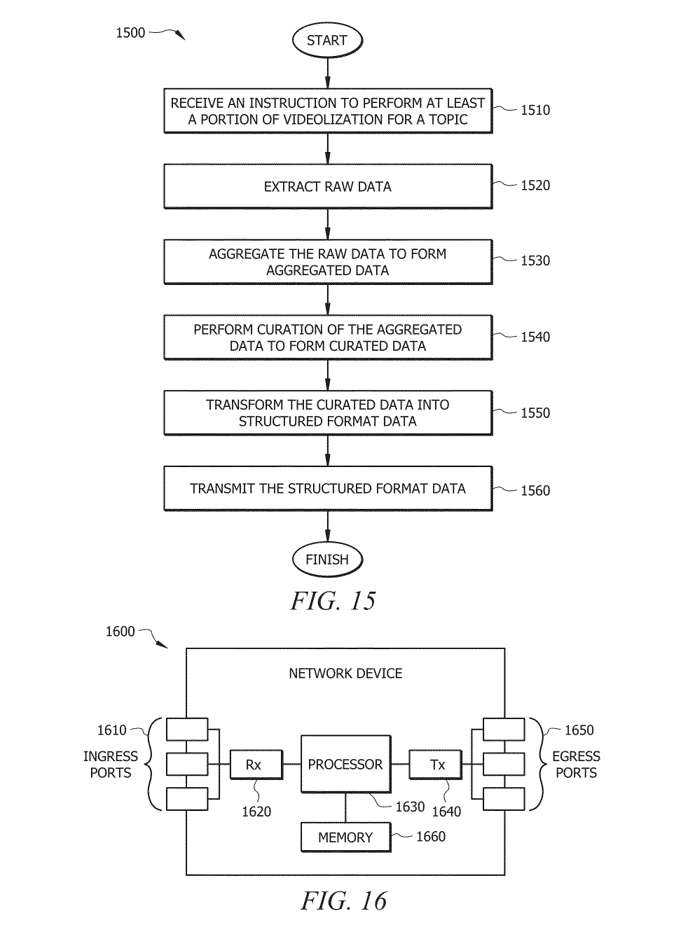

FIG. 16 is a schematic diagram of a network device 1600. The network device 1600 may be suitable for implementing the disclosed embodiments. The network device 1600 comprises ingress ports 1610 and receiver units (Rx) 1620 for receiving data; a processor, logic unit, or central processing unit (CPU) 1630 to process the data; transmitter units (Tx) 1640 and egress ports 1650 for transmitting the data; and a memory 1660 for storing the data. The network device 1600 may also comprise optical-to-electrical (OE) components and electrical-to-optical (EO) components coupled to the ingress ports 1610, receiver units 1620, transmitter units 1640, and egress ports 1650 for egress or ingress of optical or electrical signals.

The processor 1630 may be implemented by hardware and software. The processor 1630 may be implemented as one or more CPU chips, cores (e.g., as a multi-core processor), field-programmable gate arrays (FPGAs), application specific integrated circuits (ASICs), and digital signal processors (DSPs). The processor 1630 is in communication with the ingress ports 1610, receiver units 1620, transmitter units 1640, egress ports 1650, and memory 1660.

The memory 1660 comprises one or more disks, tape drives, and solid-state drives and may be used as an over-flow data storage device, to store programs when such programs are selected for execution, and to store instructions and data that are read during program execution. The memory 1660 may be volatile and non-volatile and may be read-only memory (ROM), random-access memory (RAM), ternary content-addressable memory (TCAM), and static random-access memory (SRAM).

While several embodiments have been provided in the present disclosure, it may be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and may be made without departing from the spirit and scope disclosed herein.

What is claimed is:

1. An apparatus comprising:
a data acquisition module configured to:
extract raw data, and
aggregate the raw data to form aggregated data;
a data curation module coupled to the data acquisition module and configured to:
perform curation of the aggregated data to form curated data, and
transform the curated data into structured format data; and
a transmitter coupled to the data curation module and configured to transmit the structured format data.

2. The apparatus of claim 1, wherein curation is a process of determining what data to present and how to present the data.

3. The apparatus of claim 1, wherein the data acquisition module comprises:
a social extraction module configured to extract raw social data;
an encyclopedia extraction module configured to extract raw education data;
an electronic program guide (EPG) extraction module configured to extract raw television (TV) program and movie data; and
a news extraction module configured to extract raw news data.

4. The apparatus of claim 1, wherein the data curation module comprises a natural language processing (NLP) module configured to extract text from the aggregated data using machine learning methods.

5. The apparatus of claim 4, wherein the data curation module further comprises a semantic analysis module configured to annotate the aggregated data to associate names, attributes, comments, descriptions, or other data with the aggregated data.

6. The apparatus of claim 5, wherein the data curation module further comprises a sentiment analysis module configured to perform opinion mining.

7. The apparatus of claim 6, wherein the data curation module further comprises a multimodal summarization module configured to convert the aggregated data into less complex data.

8. The apparatus of claim 7, wherein the data curation modulate further comprises an information presentation module configured to determine how to present the aggregated module.

9. The apparatus of claim 8, wherein the information presentation module is further configured to generate an avatar to read text derived from the aggregated data.

9. The apparatus of claim 1, wherein the structured format data is an Extensible Markup Language (XML) document.

10. The apparatus of claim 1, wherein the apparatus is a server and the transmitter is further configured to transmit the structured format data to a client.

11. An apparatus comprising:
a receiver configured to receive structured format data that is based on curation of raw data;
a video generation module coupled to the receiver and configured to:
perform text-to-speech (TTS) conversion of the structured format data,
perform visual optimization of the structured format data,
perform encoding, decoding, or both encoding and decoding of the structured format data, and
render the structured format data to form a video; and
presentation components coupled to the video generation module and configured to present the video.

12. The apparatus of claim 11, wherein the apparatus is a client and the receiver is further configured to receive the structured format data from a server.

13. The apparatus of claim 11, wherein the apparatus is a television (TV), and the video comprises text data, audio data, and video data.

14. A method comprising:
generating a home menu comprising an application icon associated with an application;
receiving a first instruction to execute the application;
generating, in response to receiving the first instruction, a channel menu comprising a channel icon associated with a channel, wherein the channel is a representation of a category of data;
receiving a second instruction to execute the channel;
generating, in response to receiving the second instruction, a topic menu comprising a topic icon associated with a topic, wherein the topic is a representation of a sub-category of the data;
receiving a third instruction to execute the topic; and
performing, in response to receiving the third instruction, at least a portion of videolization for the topic.

15. The method of claim 14, wherein performing at least the portion of videolization for the topic comprises:
determining whether a stored video of the topic is available;
presenting the stored video if the stored video is available;
generating a new video for the topic if the stored video is not available; and
presenting the new video if the stored video is not available.

16. The method of claim 15, wherein generating the new video comprises:
performing text-to-speech (TTS) conversion of received data;
performing visual optimization of the received data;
encoding, decoding, or both encoding and decoding of the received data; and
rendering the received data.

17. A method comprising:
receiving an instruction to perform at least a portion of videolization for a topic;
extracting raw data in response to the instruction;
aggregating the raw data to form aggregated data;
performing curation of the aggregated data to form curated data;
transforming the curated data into structured format data; and
transmitting the structured format data.

18. The method of claim 17, wherein the extracting raw data comprises extracting raw data from one of extracting raw social data, raw educational data, extracting raw television (TV) program and movie data, and raw news data.

19. The method of claim 17, wherein the performing curation comprises:
performing natural language processing (NLP);
performing semantic analysis;
performing sentiment analysis;
performing multimodal summarization; and
performing information presentation.

20. The method of claim 17, further comprising:
performing text-to-speech (TTS) conversion of received data;
performing visual optimization of the received data;
encoding, decoding, or both encoding and decoding of the received data; and
rendering the received data.
